(19) United States
(12) Patent Application Publication
(10) Pub. No.: US 2014/0335226 A1
(43) Pub. Date: Nov. 13, 2014

(54) NUTRITIOUS BEVERAGE FORMED FROM FLUID ACID WHEY AND A METHOD OF FORMING A NUTRITIOUS BEVERAGE BY COMBINING FLUID ACID WHEY AND A JUICE

(71) Applicant: Lawrence I. Bell, Green Bay, WI (US)

(72) Inventor: Lawrence I. Bell, Green Bay, WI (US)

(21) Appl. No.: 14/253,530

(22) Filed: Apr. 15, 2014

Related U.S. Application Data
(60) Provisional application No. 61/820,981, filed on May 8, 2013.

(51) Int. Cl. A23C 21/02; A23L 1/06; A23C 21/08; A23C 21/00

(52) U.S. Cl. CPC A23C 21/023; A23C 21/00; A23L 1/06; A23C 21/08
USPC 426/61; 426/580; 426/576; 426/311

(57) ABSTRACT

A nutritious beverage formed from fluid acid whey and a method of forming a nutritious beverage by combining fluid acid whey with a juice.

### CROSS-REFERENCE TO RELATED APPLICATION

This application is a non-provisional of Provisional Application Ser. No. 61/820,981, filed May 8, 2013 which is incorporated herein by reference in its entirety.

### FIELD OF THE INVENTION

This invention relates to a nutritious beverage formed from fluid acid whey and a method of forming a nutritious beverage by combining fluid acid whey with a juice.

### BACKGROUND OF THE INVENTION

The production of fermented dairy products, such as cheeses and some yogurts, result in the production of whey. There are basically two types of whey produced from various types of cheese manufacture, sweet whey and acid whey. When milk is used to make Cheddar Cheese, ten pounds of milk is needed to make about one pound of cheese. This results in about nine pounds of sweet whey byproduct. Whey is the watery part of milk that separates from the curds, as in the process of making cheese. Fluid sweet whey was once considered a byproduct with very little value. However, fluid sweet whey has become a valuable product based primarily upon its high nutritional quality protein.

Whey produced from the manufacture of hard cheeses, such as Cheddar, Colby, Swiss and Mozzarella is generally classified as “sweet whey”. Sweet whey is readily converted into a variety of other products, such as dried whey, whey protein concentrates, lactose and whey protein isolates. Sweet whey generally has a pH of greater than about 6.0 when it is separated from the cheese curd in the cheese making process.

Fluid acid whey generally has a pH of less than about 5.5 when separated from the cheese curd in the cheese making process. Fluid acid whey can be a liquid, or dried into a dry powder. In addition, the acid whey can be a concentrate or filtered to form an acid whey permeate. In either the liquid or dry form, fluid acid whey has a lower pH than sweet whey. Fluid acid whey is separated from cheese only after there has been more lactic acid development from the fermentation of the lactose of milk. In the manufacture of Greek style yogurt, acid whey is separated from the yogurt mass by the straining process only after sufficient acid development. Fluid acid whey has essentially no economic value. Cheese and yogurt manufacturers have not been able to develop a profitable use for fluid acid whey. Much of the fluid acid whey now produced is spread on farm fields as nutrients for crops. Fluid acid whey is also returned back to farmers for feeding livestock. Dairy facilities that produce fluid acid whey frequently pay a trucker to haul the fluid acid whey away. Fluid acid whey is not processed into other products because it is difficult to dry, the flavor is not desirable, and the high mineral level adds to the salty flavor. Furthermore, the high mineral content of acid whey can result in the formation of an undesirable mineral coating on the equipment which requires extra cleaning to remove it.

Now a nutritious beverage has been invented using fluid acid whey and a method of forming a nutritious beverage by combining fluid acid whey with a juice.

### SUMMARY OF THE INVENTION

Briefly, this invention relates to a nutritious beverage made from fluid acid whey, and a method of forming a nutritious beverage by combining the fluid acid whey with a juice. The nutritional beverage can include from between about 80% to about 99% by weight of fluid acid whey, from between about 0.25% to about 10% by weight of a flavoring, and from between about 0.001% to about 10% by weight of a sweetener.
1. The method of forming a nutritional beverage includes the steps of mixing fluid acid whey with a juice to form a mixture. The mixture is then heated to a temperature of about 161° F. or higher to pasteurize it. The pasteurized mixture is then cooled to a temperature of less than about 55° F. to form a nutritional beverage.

The general object of this invention is to form a nutritious beverage from fluid acid whey. A more specific object of this invention is to provide a nutritious beverage from fluid acid whey which is high in potassium and sodium and can aid athletes in replacing their electrolytes.

Another object of this invention is to provide a method of forming a nutritious beverage by combining fluid acid whey with a juice. A further object of this invention is to provide a nutritious beverage which is high in calcium and phosphorous and which can be consumed by people desiring the essential nutrients for optimum bone health.

Still another object of this invention is to provide a nutritious beverage from fluid acid whey when the whey is in a liquid or dry powder form, or said fluid acid whey is a concentrate or a permeate.

Other objects and advantages of the present invention will become more apparent to those skilled in the art in view of the following description and the accompanying drawings.

### BRIEF DESCRIPTION OF THE DRAWINGS

FIG. 1 is a flow diagram of a nutritional beverage made from fluid acid whey.

FIG. 2 is a flow diagram of a nutritional beverage made from fluid acid whey using ultra filtration.

FIG. 3 is a flow diagram of a nutritional beverage made from concentrated fluid acid whey.

FIG. 4 is a flow diagram of a nutritional beverage made from fluid acid whey in dry powder form,

FIG. 5 is a flow diagram of a nutritious gelatin desert made from fluid acid whey.

### DETAILED DESCRIPTION OF THE INVENTION

The present invention relates to a nutritious beverage and a method of forming a nutritious beverage by combining the fluid acid whey with a juice. Whey is the watery part of milk that separates from the curds, as in the process of making cheese. There are basically two types of whey produce from the production of various types of cheese making, fluid sweet whey and fluid acid whey. Fluid sweet whey was once considered a byproduct with very little value. However, fluid acid whey has become a valuable product based primarily upon its high nutritional quality protein. Fluid acid whey produced from the manufacture of hard cheeses, such as Cheddar, Colby, Swiss and Mozzarella is generally classified as “sweet whey”. Sweet whey is readily converted into a variety of other products, such as dried whey, whey protein concentrates, lactose and whey protein isolates. Sweet whey generally has a pH of greater than about 6.0 at the time it is separated from cheese curd during the cheese production process.

Fluid acid whey has a pH of less than about 5.5 at the time the whey is separated from cheese curd during the cheese production process. This is less than the pH of sweet whey. Fluid acid whey is separated from cheese only after there has been more acid development from the lactic acid fermentation of milk. Up until now, fluid acid whey has had essentially no economic value.

The fluid acid whey of this invention uses acid whey in liquid form having a lower pH than sweet whey. The fluid acid whey generally has a pH of less than about 5.5. More desirably, the fluid acid whey has a pH of less than about 5.2. Even more desirable, the fluid acid whey has a pH of less than about 4.8. Most desirable, the fluid acid whey has a pH of about 4.6.

This invention will be described using fluid acid whey. By “fluid” it is meant a continuous amorphous substance whose molecules move freely past one another and that assumes the shape of its container. Fluid acid whey can also be a concentrate or a permeate. In addition, the fluid acid whey can be treated to be a dry powder. For the purpose of discussion hereafter, the term “fluid acid whey” will cover all such possibilities.

Fluid acid whey is a byproduct from the fermentation and production of low pH cheese, such as cottage cheese and cream cheese. The production of Greek Yogurt by the stained process also results in the production of fluid acid whey. Greek yogurt acid whey is even more difficult to find a use for than acid whey from cottage cheese and cream cheese because of the higher mineral levels, higher acidity, and lower protein levels. The higher level of calcium of Greek Yogurt whey provides an additional benefit to the nutritional beverage that is focused on providing bone building nutrients. The rapid growth of Greek Yogurt has resulted in dramatic increases in the production of fluid acid whey. Developing a profitable outlet for acid whey would increase the overall profitability of the production of Greek Yogurt, cottage cheese and cream cheese, as well as solving a disposal problem.

Fluid acid whey is also the byproduct from the production of acid casein. Acid casein is produced by the addition of a food grade acid to the milk to precipitate the casein. This process also results in fluid acid whey that has a pH and composition that is essentially the same as fluid acid whey from fermentation.

Fluid acid whey has unique nutritional attributes that would be beneficial to large segments of the population if suitable products could be developed which could utilize the fluid acid whey. A nutritional comparison between sweet whey and fluid acid whey is presented in Table 1. This comparison appeared in the United States Department of Agriculture Handbook No. 8-1 entitled: “COMPOSITION OF FOODS—DAIRY AND EGG PRODUCTS, RAW-PROCESSED-PREPARED” by Consumer and Food Economics Institute, November, 1976. Item No. 01-112 which appears in this handbook provides information on fluid acid whey, and item No. 01-114 provides information on fluid sweet whey. Items No. 01-113 and 01-01-115 provides information on dry acid whey and dry sweet whey, respectively.

TABLE 1

| | Protein | Lactose | Calcium | Phosphorous | Potassium | Sodium |
|---|---|---|---|---|---|---|
| Fluid | 0.76 g | 5.12 g | 103 mg | 78 mg | 143 mg | 48 mg |
| Acid Whey | | | | | | |
| Fluid acid | | | 162 mg | 125 mg | 242 mg | 57 mg |
| whey Permeate | | | | | | |
| Fluid | 0.85 g | 5.14 g | 47 mg | 46 mg | 161 mg | 54 mg |
| Sweet Whey | | | | | | |
| Greek | 0.3 g | 4.3 g | 123 mg | | | |
| Yogurt | | | | | | |
| acid whey* | | | | | | |
| Dry Acid | 11.73 g | 73.5 g | 2054 mg | 1348 mg | 2288 mg | 968 mg |
| Whey | | | | | | |
| Dry | 12.93 g | 74.5 g | 796 mg | 932 mg | 2080 mg | 1079 mg |
| Sweet Whey | | | | | | |

Units: in quantity per 100 grams
g = gram. A gram is a metric unit of mass.
mg = milligram. A milligram is a metric unit of mass equal to one thousandth (10⁻³) of a gram.
Greek yogurt acid whey* - Data from presentation at the 2013 Wisconsin Cheese Makers Association meeting: How to Deal with Whey Processing Issues - Wisconsin Center for Dairy Research

One can readily gleam from Table 1 that fluid acid whey is lower in protein, potassium and sodium when compared to fluid sweet whey but is much higher in calcium and phosphorous. In fact, fluid acid whey contains more than two times the amount of calcium than fluid sweet whey. Calcium and phosphorous are essential elements for building strong bones. These elements are beneficial to all segments of the human population. Furthermore, calcium and phosphorous are essential elements in the development of bone density. Calcium is a soft metallic element that is a basic component of animals and plants and constitutes approximately 3 percent of the Earth's crust. Calcium occurs naturally in limestone, gypsum and fluorine. Calcium has an atomic number of 20; an atomic weight of 40.08; a melting point of from between 842° C. (Celsius) to 848° C.; a boiling point of 1,4870° C.; a specific gravity of 1.55 and a valence of 2. Phosphorous relates to or contains phosphorus. Phosphorous has a valence of 3 or a valence lower than that of a comparable phosphoric compound. Phosphorus has an atomic number of 15; an atomic weight of 30.9738; a melting point (white) of 44.1° C.; a boiling point of 280° C.; a specific gravity (white) of 1.82; and a valence of 3, 5.

An economical way has been invented to manufacture acid whey into a nutritional beverage. By “nutrition” it is meant the process of nourishing or being nourished, especially the process by which a living organism assimilates food and uses it for growth and for maintenance of tissue. By “beverage’ it is meant any one of various liquids for drinking, usually excluding water.

The various nutritional beverages of this invention can be marketed as: a drink to improve bone health, a nutritional sport drink, a nutritional juice drink, a drink used to replenish electrolytes, or as some other type of beneficial beverage. This nutritional drink can improve bone health and is very beneficial to older adults, especially women, who may suffer from osteoporosis. By “osteoporosis” it is meant a disease in which the bones become extremely porous, are subject to fracture, and heal slowly. Osteoporosis occurs especially in women after menopause and often leads to curvature of the spine.

A nutritional beverage formed from fluid acid whey can be a highly nutritious product that provides many of the essential amino acids required for human health. Amino acids are the building blocks of the human body aiding in everything from protein synthesis to energy production. Of the standard twenty two (22) amino acids present in the body, nine (9) are essential amino acids, which means that they cannot be made by the body and must therefore be obtained through a person's diet. Whey protein is unique in that it contains the highest amount of essential amino acids, known as branch chain amino acids (isoleucine, valine and leucine) found in food. Leucine is directly linked to muscle protein synthesis, which is an important part of recovery for all athletes.

Whey proteins are beneficial in aiding muscle recovery, building muscle mass and muscle strength. The consumption of whey protein to better one's muscle health has been known for years, in addition, athletes desire beverages that contain electrolytes. Consuming potassium and sodium replaces the electrolytes loss from sweating.

The various nutritional beverages of this invention can be manufactured in several different compositions. The composition of a first nutritional beverage includes from between about 90% to about 99% by weight of fluid acid whey. The separation of fluid acid whey into various streams can be accomplished by membrane filtration using an ultra-filtration (UF) membrane. Membrane filtration separates substances by molecular weight. UF membranes separate molecules that have a molecular weight ranging from between about 1,000 to about 1,000,000. Nutritional beverages can be made from the fluid acid whey permeate stream. In addition, a nutritional beverage could also be made from the fluid acid whey UF retentate stream which is high in whey proteins.

The fluid acid whey can be a concentrate or a permeate that is free of protein obtained by ultra filtration. In addition, the fluid acid whey can be a retenate that is higher in protein than fluid acid whey. By “ultra filtration” it is meant producing a protein stream and a protein free fraction stream.

By “permeate” it is meant the fluid that passes thru the filtration membrane. The molecules that are less than the size of the pores of the filter membrane will permeate thru the pores. The material (fluid) that passes thru the membrane is referred to as “permeate”.

By “retenate” it is meant the material that has a molecular size too large to pass thru the filter membrane and is thus retained on the feed side of the filtration membrane.

### Nutritional Beverage

The composition of a first nutritional beverage includes from between about 80% to about 99% by weight of fluid acid whey, from between about 0.25% to about 10% by weight of a flavoring, and from between about 0.001% to about 10% by weight of an artificial sweetener. Desirably, the composition of this first nutritional beverage includes from between about 90% to about 98% by weight of fluid acid whey, from between about 0.5% to about 6% by weight of a flavoring, and from between about 0.01% to about 5% by weight of a an artificial sweetener. More desirably, the composition of this first nutritional beverage includes from between about 93% to about 97% by weight of fluid acid whey, from between about 5% to about 3% by weight of a flavoring, and from between about 0.1% to about 3% by weight of an artificial sweetener. Even more desirably, the composition of this first nutritional beverage includes about 94% to about 96% by weight of fluid acid whey, from between about 1.0% to about 4% by weight of a flavoring, and from between about 0.1% to about 2% by weight of an artificial sweetener. Most desirably, the composition of this first nutritional beverage includes about 96% by weight of fluid acid whey, less than about 2% by weight of a flavoring, and less than about 2% by weight of an artificial sweetener.

The flavoring can be any natural or artificial flavoring known to those skilled in the art. The exact flavoring which is used can vary. The flavor intensity and/or concentration of flavoring can vary. The higher the flavoring concentration, the lesser the amount of the flavoring that is needed to achieve the target flavor profile in the beverage. Fruit flavoring is the most common. Examples of fruit flavoring include but are not limited to: pomegranate, peach, raspberry, strawberry, lemon, lime, cranberry, apple, orange, cherry, apricot, etc. Other types of flavors can also be used. For example, the nutritional beverage can be flavored to taste like chocolate milk, eggnog, etc. By “chocolate” it is meant a fermented, roasted, shelled, and ground cacao seeds, often combined with a sweetener or flavoring agent; a beverage of milk and chocolate. By “eggnog” it is meant a drink consisting of milk or cream, sugar, and eggs beaten together and often mixed with alcoholic liquor, such as rum or brandy.

The sweetener can be a natural sweetener or an artificial sweetener. Examples of natural sweeteners include but are not limited to: sugar, corn syrup solids, fructose, maltose, sucrose, dextrose. Other natural sweeteners that are known to those skilled in the art can also be used. The sweetener could also be an artificial sweetener. Examples of artificial sweeteners include but are not limited to: aspartame, saccharin, acesulfame potassium and sucralose. SPLENDA® is a commercial brand of an artificial sweetener that was used in producing our nutritional beverage. SPLENDA® is a registered trademark of Johnson & Johnson Corporation having an office at One Johnson & Johnson Plaza, New Brunswick, N.J. 08933. SPLENDA® is a dry mixture of dextrose, maltodextrin and sucralose. Sucralose is the artificial sweetener compound in SPLENDAS. Other artificial sweeteners that are known to those skilled in the art can also be used.

The composition of this first nutritional beverage can also include an enzyme. By “enzyme” it is meant any of numerous proteins or conjugated proteins produced by living organisms and functioning as biochemical catalysts. The composition of this first nutritional beverage can include from between about 0.001% to about 2% by weight of an enzyme.

The composition of this first nutritional beverage can further include a pH neutralizer. For example, a pH neutralizer can raise the pH of the beverage. About 0.5 grams of Trisodium Phosphate (TSP) will increase the pH of 100 grams of fluid acid whey from about 4.6 to about 5.2. About 1.0 grams of TSP will raise the pH of 100 grams of fluid acid whey to about 6.0. About 1.5 grams of TSP will increase the pH of fluid acid whey to about pH 6.4. The amount of pH neutralizer that is added will depend upon the initial pH of the fluid acid whey and the desired final pH value.

By “pH neutralize” it is meant to make a solution neutral; to cause an acid or a base to undergo neutralization

Various pH neutralizers can be used. Examples of a base pH neutralizer include but are not limited to: sodium bicarbonate, sodium phosphate and sodium hydroxide. Other pH neutralizers known to those skilled in the art can also be used.

The nutritional beverage can also be formed with a different composition.

The composition of a nutritional beverage that uses sugar as the sweetener also includes from about 80% to about 96% fluid acid whey, from between about 0.2% to about 15% by weight of a flavoring, and from between about 1% to about 15% by weight of sugar. Desirably, the composition of this sugar sweetened nutritional beverage includes from between about 85% to about 96% by weight of fluid acid whey, from between about 0.3% to about 10% by weight of a flavoring, and from between about 2% to about 15% by weight of sugar. More desirably, the composition of this first nutritional beverage includes from between about 90% to about 96% by weight of fluid acid whey, from between about 0.4% to about 5% by weight of a flavoring, and from between about 3% to about 10% by weight of sugar. Even more desirably, the composition of this first nutritional beverage includes about 87% to about 91% by weight of fluid acid whey, from between about 0.5% to about 4% by weight of a flavoring, and from between about 5% to about 10% by weight of a sugar. Most desirably, the composition of this first nutritional beverage includes about 90% by weight of fluid acid whey, less than about 4% by weight of a flavoring, and less than about 10% by weight of sugar.

Fluid acid whey can alternatively be produced by reconstituting a dry acid whey powder. Adding about 7 grams of dry acid whey powder to about 93 grams of water and mixing, will results in a solution that has the same composition of fluid acid whey. The reconstituted acid whey can then be used as fluid acid whey as described elsewhere in this application.

A nutritional beverage made from fluid acid whey can also be made by combining all the ingredients together in a dry state, at the proper proportions, to create a dry, nutritious beverage base. Water can then be added to this dry, nutritious beverage base to form the final nutritious beverage.

TABLE 2

| | Example 1 | Example 2 | Example 3 | Example 4 |
|---|---|---|---|---|
| | Whey Product Description | | | |
| | | | | 20% Solids, |
| | Pasteurized | Acid Whey | Dry Whey | Acid Whey |
| | Acid Whey | Permeate | Powder | Concentrate |
| | (% by weight) | (% by weight) | (% by weight) | (% by weight) |
| Whey Component Level | 97% | 97% | 7% | 31% |
| Natural Flavoring | 2% | 2% | 2% | 2% |
| SPLENDA ® Sweetener | 1% | 1% | 1% | 1% |
| Grape Juice | | 27% | | |
| Water | | | 90% | 66% |

| | Example 5 | Example 6 | Example 7 | Example 8 |
|---|---|---|---|---|
| | Whey Product Description | | | |
| | Fluid Acid | Dry Acid | Fluid Acid | Dry Acid |
| | Whey | whey | Whey | whey |
| Whey Component Level | 50% | 7% | 75% | 7%* |
| Apple juice | 50% | 93% | | |
| Grape juice concentrate | | | 25% | |
| Dry Peach Tea flavoring | | | | 0.5%* |
| SPLENDA ® Sweetener | | | | 1%* |
| Water | | | | 91.5% |

*Note:
Ingredients that may be combined and mixed to form a dry, nutritious beverage base can be subsequently dissolved in water.

The method of making the nutritional beverage described above was formulated as follows. Fluid acid whey was produced by inoculating a half gallon of skim milk with a mesophilic lactic acid culture and incubating at about 92° F. until the pH reached 4.7. Rennet enzyme was added at the time of culture inoculation at the rate of 2 drops per ½ gallon of milk to facilitate curd and whey separation. The fluid acid whey was separated from the curd by straining through a cheese cloth purchased from New England Cheesemaking Supply Company having an office in South Deerfield, Mass., One hundred (100) grams of acid whey was measured into a container. One (1) gram of a sugar substitute (SPLENDA®) and a Natural Pomegranate flavor was added to the fluid acid whey and these ingredients were mixed to form a nutritional beverage. The fluid acid whey was then heated in a Mason jar to 172° F. The heated, fluid acid whey was held at this temperature for 15 seconds. By “Mason jar” it is meant a wide-mouthed glass jar with a screw top, used for canning and preserving food, which was invented by John Mason. The heated, fluid acid whey was then placed in a refrigerator and cooled to about 40° F. One (1) gram of SPLENDA® is equivalent to 2 teaspoons of sugar (about 9 grams). The natural Pomegranate flavor was obtained from Carmi Flavor & Fragrance Co., Inc. having an office at 6030 Scott Way, Commerce, Calif. 90040.

### Formulation Options

1. Other powder or liquid concentrated flavors may be substituted for the pomegranate flavor. Other natural flavors produced include: strawberry, raspberry, peach, mango, grape, tangerine, lemon-lime, and orange. Artificial flavor may also be used in place of natural flavors.
2. Fruit juice, fruit juice concentrate, and fruit juice powder may be substituted for artificial and natural flavors in part or in total.
3. Finished product may be carbonated.
4. Vitamins and minerals may be added to meet specific nutritional targets. For example, vitamin D and/or magnesium may be added to facilitate Calcium absorption.
5. Food grade acid may be added to increase tartness for some flavors to match the flavor of the natural food item.
6. Food grade acid may be added to produce a microbiologically shelf stable beverage.
7. Possible food grade acid (citric, lactic, adipic, malic, tartaric, phosphoric, ascorbic)
8. Various natural and artificial flavors may be used that are sourced from flavor manufacturing companies.
9. Artificial sweeteners that may be used: aspartame, acesulfame potassium, sucralose.
10. Lactase enzymes may be used as an alternative to increase sweetness and to make the beverage acceptable to lactose intolerant individuals.
11. Possible sweeteners—sugar, corn syrup solids, fructose, maltose, sucrose, and dextrose.
12. Colors (natural and artificial colors, FD&C colors). FD&C colors are the colors certified and allowed by the Federal Drug Administration (FDA) for the food, pharmaceutical, cosmetic, and personal care industry.
13. An additive to raise the pH may be used to reduce the acid or tartness of some flavor beverages sodium bicarbonate, sodium phosphate and sodium hydroxide.
14. Food grade acid may be added to reduce the pH to a level to allow for longer self-life and to also allow for non-refrigerated storage & distribution. Acidifying beverages to a pH value of about 3.5 is a common practice to allow for unrefrigerated distribution and sale.

Finished Nutritional Beverage Targets:
1. Flavor—Pleasant fruity flavor similar to the declared flavor descrption, with tartness to simulate the fruit target.
2. Product pH: Target a pH of about 4.6. The pH may range from about 3.5 to about 7.
3. Appearance: Can vary from opaque to transparent.
4. Color: colored to simulate the color of the fruit juice. For example, a raspberry beverage will have a reddish color and a peach beverage will have a yellow/orange color.
5. Shelf-life:
   Refrigerated shelf life can range from about 30 to about 45 days or longer for pasteurized products.
   Shelf life can be lengthen by employing extended shelf life (ESL) processing that is used for some fluid beverages, including milk products.

### Nutritional Fruit Drink

The nutritional beverage can also be formulated as a nutritional fruit drink containing a certain percentage by weight of fruit juice. Table 3 provides three examples of nutritional beverages containing different percentages by weight of fruit juice.

TABLE 3

| | Example 1 | Example 2 | Example 3 |
|---|---|---|---|
| | (% by weight) | (% by weight) | (% by weight) |
| Fluid Acid Whey | 75% | 50% | |
| Apple Juice | 25% | 30% | 93% |
| Acid Whey Powder | | | 7% |

A nutritional beverage can include from between about 50% to about 75% by weight of fluid acid whey and from between about 25% to about 50% by weight of juice. Desirably, the nutritional beverage includes from between about 55% to about 75% by weight of fluid acid whey and from between about 25% to about 45% by weight of juice, More desirably, the nutritional beverage includes from between about 60% to about 75% by weight of fluid acid whey and from between about 25% to about 40% by weight of juice. Even more desirably, the nutritional beverage includes from between about 65% to about 75% by weight of fluid acid whey and from between about 25% to about 35% by weight of juice. Most desirably, the nutritional beverage includes about 75% by weight of fluid acid whey and about 25% by weight of juice.

The nutritional beverage can also be made from a combination of a fruit juice and a flavoring. The combination of the flavoring and the fruit juice can range from between about 5% to about 50% by weight, and the amount of the fluid acid whey can range from between about 50% to about 95% by weight.

The percent by weight of the juice which is present in the nutritional beverage can vary. Because of the flavor, concentration, chemical makeup, cost, etc. of different fruit juices, the percentage by weight of a particular fruit juice, that is used, can vary.

One specific example of a nutritional beverage made from fluid acid whey and a fruit juice was made using equal amounts MOTT'S® 100% Apple Juice and fluid acid whey. MOTT'S is a registered trademark of Mott's Inc. having an office at 900 King Street, Rye Brook, N.Y. 10573.

The nutritional beverage can also be made by adding fluid acid whey, in dry powder form, to a fruit juice. Seven percent (7%) by weight of fluid acid whey in dry powder form and 93% by weight Mott's Apple Juice was mixed to form a nutritional beverage high in calcium.

Examples 1 and 2, listed in Table 3, were prepared as follows:

### Example 1

Three parts by weight of fluid acid whey and one part by weight of MOTT'S® apple juice were combined to form a 75/25% by weight fluid acid whey/apple juice blend. The fluid acid whey was heated in a Mason jar to a temperature of 172° F. The heated, fluid acid whey was then placed in a refrigerator and cooled to a temperature of about 40° F. Six (6) ounces of the cooled fluid acid whey was then poured into a measuring glass. Two (2) ounces of MOTT'S brand apple juice, having a temperature of about 40° F., was then poured into the measuring glass to bring the total number of ounces up to eight (8). This mixture was then gently mixed and subsequently poured into an eight (8) ounce bottle, caped, and placed in a refrigerator maintained at a temperature of 40° F. This cooled nutritional fruit drink represented the finished product.

### Example 2

Two parts by weight of fluid acid whey and two parts by weight of MOTT'S® brand apple juice were combined to form a 50/50% by weight acid whey/apple juice blend. Fluid acid whey was heated in a Mason jar to a temperature of 172° F. The heated, fluid acid whey was then placed in a refrigerator and cooled to a temperature of about 40° F. Four (4) ounces of the cooled fluid acid whey was then poured into a measuring glass. Four (4) ounces of the MOTT'S® brand apple juice, having a temperature of 40° F., was then poured into the measuring glass to bring the total number of ounces to eight (8). This mixture was then gently mixed and subsequently poured into an eight (8) ounce bottle, caped, and placed in a refrigerator maintained at a temperature of 40° F. This cooled, nutritional beverage represented the finished product.

### Example 3

A third nutritional beverage was made using a permeate of fluid acid whey, grape juice, a grape flavoring, and an artificial sweetener. SPLENDA® is one kind of artificial sweetener that can be used. The grape juice was Welch's Grape Juice. Welch's has an office in Concord, Mass. The grape flavoring was natural grape flavoring. The composition of this third nutritional beverage included from between about 50% to about 90% by weight of the fluid acid whey permeate, from about 5% to about 50% by weight of grape juice, from between about to about 0.25% to about 5% by weight of a grape flavoring, and from between about 0.001% to about 5% by weight of an artificial sweetener. Desirably, the composition of the third nutritional beverage can include from between about 55% to about 85% by weight of fluid acid whey permeate, from about 10% to about 45% by weight of a grape juice, from between about 0.5% to about 4% by weight of a grape flavoring, and from between about 0.01% to about 4% by weight of an artificial sweetener. More desirably, the composition of the third nutritional beverage can include from between about 60% to about 80% by weight of fluid acid whey permeate, from about 15% to about 40% by weight of grape juice, from between about 1% to about 3% by weight of a flavoring, and from between about 0.1% to about 3% by weight of an artificial sweetener. Even more desirably, the composition of the third nutritional beverage can include about 65% to about 75% by weight of fluid acid whey permeate, from about 20% to about 35% by weight of grape juice, from between about 1.5% to about 2.5% by weight of a flavoring, and from between about 0.5% to about 3% by weight of an artificial sweetener. Most desirably, the composition of the second nutritional beverage includes about 70% by weight of fluid acid whey permeate, from about 28% to about 30% by weight of fruit juice, less than about 2% by weight of a flavoring, and less than about 1% by weight of an artificial sweetener.

The method of making the third nutritional beverage was made as follows. The specified quantities of the various recipe ingredients (fluid acid whey permeate, grape juice, grape juice flavoring, and an artificial sweetener) were mixed and heated in a Mason jar in a microwave oven to a temperature of 172° F. The heated beverage was then sealed in the Mason jar and placed in a refrigerator and cooled to a temperature of 40° F. to form a finished product.

### Example 4

A fourth nutritional beverage was made using fluid acid whey in dry powder form. Seven percent (7%) by weight of a dry, powder acid whey, two (2) grams of a dry pomegranate flavoring, and one (1) gram of an artificial sweetener (SPLENDA®) were combined into a dry mix. Ten (10) grams of the dry mix was then dissolved in ninety (90) grams of water and was mixed to form a fourth nutritional beverage which was high in calcium.

It should be noted that the fluid acid whey, in the above examples, was heated so as to pasteurize it. By “pasteurization” it is meant the act or process of heating a beverage or other food, such as milk or beer, to a specific temperature for a specific period of time in order to kill microorganisms that could cause disease, spoilage or undesired fermentations. The Pasteurized Milk Ordinance (PMO) requires milk to be pasteurized at a minimum temperature of 161° F. for 15 seconds to be legally pasteurized. Many processors heat milk above the legal minimum temperature to aid in extending the shelf-life of milk. The same can be done with the nutritional beverage of this invention which is formed from fluid acid whey.

### Gelatin Dessert

A nutritional gelatin dessert can also be formulated from the nutritional beverage. By “gelatin” it is meant a colorless or slightly yellow transparent jelly. Gelatin is a mixture of peptides and proteins produced by partial hydrolysis of collagen extracted from the skin, bones, and connective tissues of animals such as domesticated cattle, chicken, pigs, and fish. Gelatin is an animal protein unlike many other gelling agents used by the food industry. The gelatin can be either pork or beef gelatin. The color can vary depending upon the flavor target, for example, a cherry gelatin would be red. A gelatin dessert can include from between about 95% to about 99% by weight of the nutritional beverage, and from between about 1% to about 5% by weight of a gelatin

A method of formulating a gelatin dessert using gelatin and the nutritional beverage is as follows: One hundred (100) grams of a peach flavored, nutritional beverage was placed in a vessel and heated to a temperature of about 200° F. Four (4) grams of gelatin was added to the heated beverage and mixed. This mixture was stirred for approximately two (2) minutes until the gelatin was completely dissolved. Ninety six (96) grams of the peach flavored, nutritional beverage, at a temperature of 40° F., was added to this mixture and stirred. This mixture was then poured into containers and cooled for four (4) hours or until firm.

A gelatin desert can also be made with commercial gelatin packets sold in retail grocery stores. The fluid acid whey permeate is substituted for the water in making the gelatin desert. JELL-O® brand, sugar free gelatin and acid whey permeate was used to make a gelatin desert. JELL-O® is a registered trademark of Kraft Foods Group Brands LLC having an office at Three Lakes Drive, Northfield, Ill., 60093. One packet, (8.5 grams) of peach flavored, JELL-O® brand was added to 220 grams of fluid acid whey permeate, having a temperature of about 200° F., and mixed for two (2) minutes to dissolve the dry powder. Two hundred and twenty (220) grams of cool fluid acid whey permeate was added to the heated solution and mixed. The mixture was added to four (4) ounce cups and cooled to a temperature of about 45° F. to make a gelatin desert.

A gelatin desert was also made using fluid acid whey powder. Thirty six (36) grams of fluid acid whey powder was mixed with one packet, (8.5 grams) of peach flavored, JELL-O® brand, sugar free, gelatin powder to form 44.5 grams of a nutritious gelatin base mix. This gelatin base mix was added to 220 grams of water, having a temperature of about 200° F., and mixed for about two (2) minutes to form a solution. Two hundred and twenty (220) grams of this cool, fluid acid whey permeate was added to the solution and mixed to form a finished solution. The solution was poured into four (4) ounce cups and cooled to a temperature of about 45° F. to form a, gelatin desert.

### Method of Forming a Nutritional Beverage

A method of forming a nutritional beverage includes the steps of heating the fluid acid whey to a temperature of about 161° F. or higher for a predetermined period of time, say about 15 seconds, to pasteurize it. The fluid acid whey could be heated above 161° F., to say a temperature of from between about 165° F. to about 172° F., if desired. This higher temperature can assure the manufacturer a more complete destruction of microorganisms. Sometimes, it is advantageous to hold this elevated temperature from about 15 seconds or longer to assure that the fluid acid whey is pasteurized. The heating of the fluid acid whey to a temperature at or above 161° F., and holding the fluid acid whey at this elevated temperature for about 15-30 seconds will also prolong the shelf life of the finished nutritional beverage. From between about 50% to about 90% by weight of the heated fluid acid whey is added with from between about 10% to about 50% by weight of a fruit juice to form a mixture. The kind of fruit juice can vary. Apple juice, orange juice and grape juice are three fruit juices that work well with the fluid acid whey in forming a nutritional beverage. The mixture is then cooled to a temperature of less than about 55° F. to form the nutritional beverage.

It should be understood that a concentrate or permeate of the fluid acid whey can also be used in place of the fluid acid whey. A fluid acid whey permeate has the additional advantage of being protein free. A fluid acid whey permeate can be heated to a temperature above even 180° F. without the concern of denaturing the whey proteins.

The cooled nutritional beverage can then be transferred to individual containers, sealed and refrigerated. Desirably, the sealed containers are refrigerated to a temperature of about 40° F. The shelf life of the refrigerated nutritional beverage can vary. A standard shelf life for the nutritional beverage ranges from between about 30 days to about 45 days. However, longer shelf life periods are possible.

An alternative to the method of forming the nutritional beverage, described above, is to mix the fluid acid whey with the juice and then heat the mixture so as to pasteurize it.

Other ingredients can also be added to the fluid acid whey before it is heated and/or before it is mixed with the fruit juice. Examples of some other ingredients which can be added to the fluid acid whey or to the mixture include but are not limited to: ascorbic acid, vitamin A, B, C and/or D, magnesium, etc.

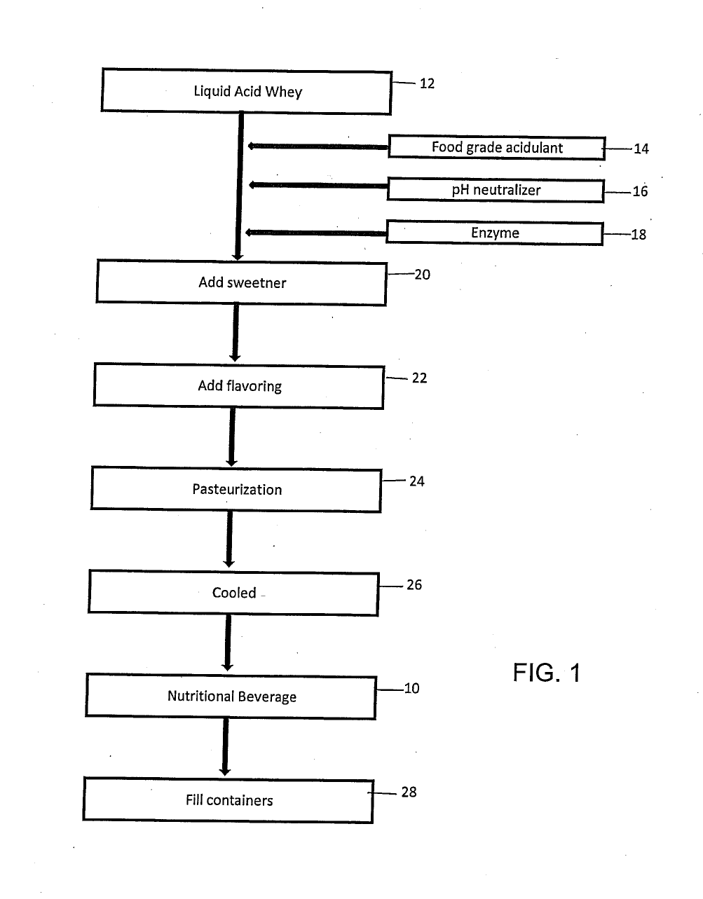

Referring now to FIG. 1, a flow diagram is shown which represents a nutritional beverage 10 made from fluid acid whey 12. The starting fluid acid whey 12 is at a cool temperature of about 40° F. At this point, optionally, a food grade acidulant 14 and/or a pH neutralizer 16 can be added to the fluid acid whey 12. An example of a food grade acidulant 14 is lactic acid. Examples of a pH neutralizer 16 include but are not limited to: sodium bicarbonate, sodium phosphate or sodium hydroxide. Adding a food grade acidulant 14 will lower the pH value of the fluid acid whey 12 while adding a pH neutralizer 16 will raise the pH value of the fluid acid whey 12.

The starting pH of the fluid acid whey 12 is usually less than about 5.5. For example, the pH value of the fluid acid whey 12 can be reduced using 88% liquid lactic acid as the food grade acidulant 14. For example, by adding one (1) gram of liquid lactic acid 14 to one hundred (100) grams of fluid acid whey 12, having a pH value of 4.8, will reduce the pH value down from about 4.8 to about 4.1. Adding one and a half (1.5) grams of liquid lactic acid 14 to one hundred (100) grams of fluid acid whey 12, having a pH value of 4.8, will reduce the pH down from about 4.8 to about 3.7. Adding two (2) grams of liquid lactic acid 14 to one hundred (100) grams of fluid acid whey 12, having a pH value of 4.8, will reduce the pH down from about 4.8 to about 3.5.

It may be desirable to reduce the lactose level in the finished nutritional beverage 10 to aid in sweetening the nutritional beverage 10. Reducing and/or eliminating the lactose will also allow consumers that are lactose intolerant to consume the nutritional beverage 10.

Another option is to add an enzyme 18 to the cool, fluid acid whey 12. One example of an enzyme 18 is a lactase enzyme. The amount of enzyme 18 which can be added can vary. Usually, the amount of enzyme which is added to the fluid acid whey 12 should range from between about 0.001% to about 0.2% by weight of the finished nutritional beverage 10. Lipase F “Amano” from Amano Enzyme U.S.A. Co., LTD was added at the rate of 0.01 grams of enzyme to 100 grams of acid whey and held at about 40° F. for 2 days, resulting in a whey with a slightly sweeter flavor. Lipase F :Amano” has an optimum activity at pH 4.5, which is well suited for converting lactose to simplifier sugars in acid whey.

The enzyme 18 can be added to the fluid acid whey 12 before it is heated to a temperature high enough to pasteurize it. A temperature of 161° F. or higher is sufficient to pasteurize the fluid acid whey 12. It is also advantageous to hold the fluid acid whey 12 at this elevated temperature for a predetermined period of time, to allow for faster conversion of the lactose to glucose and galactose. However, holding the fluid acid whey for an extended period of time for lactase activity may not be practical. Still another option is to add the enzyme 18 to the fluid acid whey 12 after it has been heated to pasteurization so as to allow the enzyme 18 to convert the lactose to glucose and galactose in the finished nutritional beverage 10. Adding the lactase after pasteurization can allow for more the use of less enzyme and longer time for enzyme activity. The conversion of lactose to glucose and galactose allows for the reduction or elimination of added sweetener in the nutritional beverage 10 recipe to achieve the desired sweetness.

Still referring to FIG. 1, a sweetener 20 is added to the cool, fluid acid whey 12. The amount of sweetener 20 which is added can vary. Usually, the amount of sweetener 20 which is added to the fluid acid whey 12 should range from between about 0.001% to about 5% by weight. Desirably, the amount of sweetener 20 which is added to the fluid acid whey 12 is from between about 0.01% to about 3% by weight. More desirably, the amount of sweetener 20 which is added to the fluid acid whey 12 is from between about 0.1% to about 3% by weight.

A flavoring 22 is also added to the cool, fluid acid whey 12. The amount of flavoring 20 which is added can vary. Usually, the amount of flavoring 20 which is added to the fluid acid whey 12 should range from between about 0.25% to about 5%. Desirably, the amount of flavoring 20 which is added to the fluid acid whey 12 is less than about 3% by weight.

Still referring to FIG. 1, the fluid acid whey 12, along with any optional food grade acidulant 14, pH neutralizer 16 and enzyme 18, and the required amount of the sweetener 20 and the flavoring 22 are then combined together. The fluid acid whey 12, the sweetener 20 and the flavoring 22, along with any of the optional ingredients 14, 16 and 18 can be mixed or agitated to form a homogeneous mixture or combination. This mixture or combination is then heated to an elevated temperature of at least 161° F. to cause pasteurization 24. It may be advantageous to hold the mixture at this elevated temperature for a short period of time, say from between about 10 seconds to about 15 seconds, to assure that proper pasteurization 24 occurs. After being pasteurized 24, the mixture is cooled 26 to a temperature of less than about 50° F. Desirably, the mixture is cooled 26 to a temperature of from between about 40° F. to about 45° F. The cooled mixture forms a nutritional beverage 10.

The nutritional beverage 10 can then be conveyed to a bottling or packaging area where containers 28 are filled with the nutritional beverage 10. The containers 28 can vary in composition, shape, size, etc. The containers 28 can be formed from a variety of materials including but not limited to: glass, plastic, thermoplastic, cardboard, aluminum, aluminum foil, a combination aluminum foil and plastic, steel, tin, a composite of two or more materials, etc. Each container 28 can be coated to allow it to safely retain the nutritional beverage 10 over a predetermined period of time. Each container 28 can also be constructed with or without a barrier layer to prevent the ingress or egress of vapor, moisture, air, oxygen, etc. The containers 28 can be rigid, such as a glass or plastic bottle, or they can be flexible, such as a plastic pouch. A flexible container 28 can vary in shape depending upon the amount of nutritional beverage 10 which is enclosed therein.

The nutritional beverage 10 can be carbonated or non-carbonated. To “carbonate” it is meant to charge the nutritional beverage 10 with carbon dioxide gas.

The containers 28 can be clear in color or be made in a specific color. Alternatively, each container 28 can be produced with two or more colors. The containers 28 can be printed, engraved, etched or contain a label. The labels can be adhered to the containers 28 by using an adhesive, a glue, tape, heat, pressure, heat and pressure, etc. Each of the containers 28 can contain an opening. The opening can be closed and sealed by a cap, a lid, by a heat seal, by a pressure seal, by a heat and pressure seal, or by any other means known to those skilled in the art.

A plurality of the filled containers 28 can be grouped together, such as into a six pack, a twelve pack, into a cardboard box or carton, etc. A plurality of the containers 28 can be packaged together to form a package of twelve, eighteen, twenty, twenty-four or more individual containers 28, similar to the way soft drinks or beer is currently marketed.

The filled containers 28 can vary in the amount of nutritional beverage 10 that each can hold. Typically, the nutritional beverage 10 can be sold in 12 ounce containers 28. However, the nutritional beverage 10 could be sold in any size container 28. Containers 28 capable of holding 4, 6, 8, 10, 12, 16, 20, 24 or 36 ounces can be utilized.

The filled containers 28 are then stored in a refrigerated room at a temperature of from between about 40° F. to about 50° F. The filled containers 28 can then be shipped to a retail outlet, such as a store, or to a designated location for sale to and/or consumption by the general public. At the retail outlet, the nutritional beverage 10 should be refrigerated to a temperature ranging from between about 40° F. to about 50° F. Shelf life for such a nutritional beverage 10 can range from about 30 days to about 45 days, or more. Once purchased, the nutritional beverage 10 should be immediately consumed or be stored in a refrigerator until it is consumed. Typically, the nutritional beverage 10 will be consumed cold.

The nutritional beverage 10 can be marketed as a sports beverage which is high in electrolytes. A common twelve ounce container 28 can include about 22% by weight of electrolytes. Electrolytes are sodium and potassium.

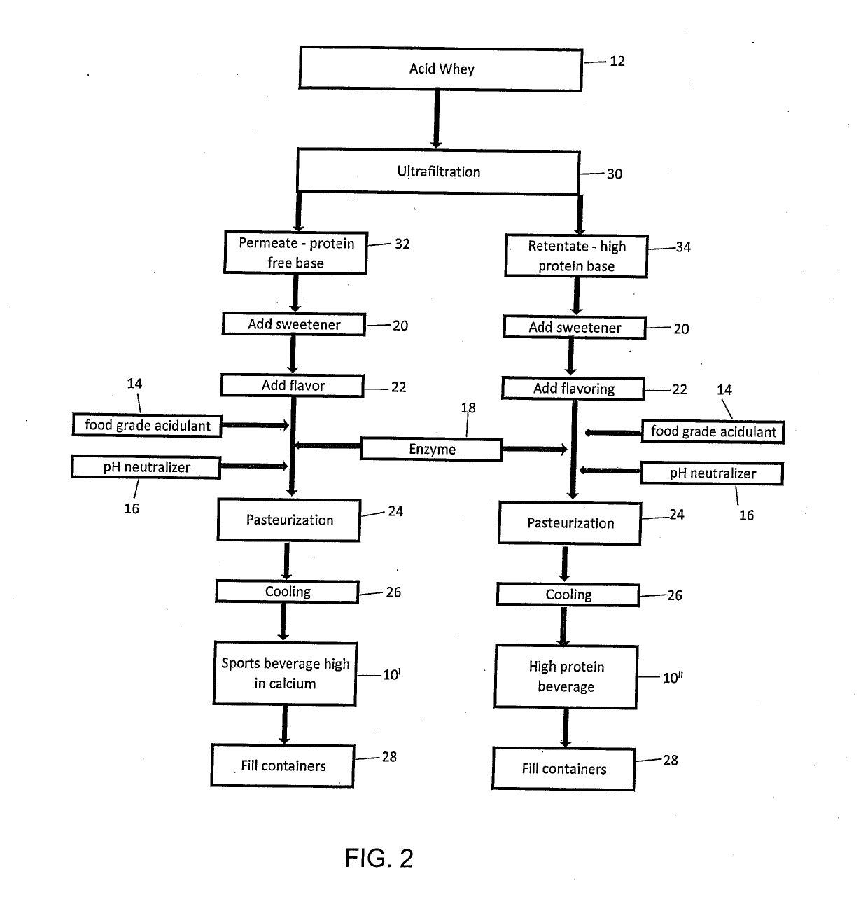

Referring now to FIG. 2, a flow diagram is shown which represents two different nutritional beverages 10′ and 10″ made from fluid acid whey 12 using ultra filtration 30. Ultra filtration 30 is a process which separates a fluid by the size of its molecules. The fluid acid whey 12 is subjected to ultra filtration 30. By “ultra filtration” it is meant producing a protein stream and a protein free fraction stream. The ultra filtration 30 uses a very fine membrane to separate the fluid acid whey by molecule size. Two separate streams are produced by the ultra filtration 30. The material which passes through the ultra filtration 30 is a permeate 32 which is protein free. This stream is shown on the left side in FIG. 2 and can be used to produce a protein free, sports beverage 10′ which is high in calcium. The material that does not pass through the membrane of the ultra filtration 30 is a retentate 34 which is high in whey protein. This stream is shown on the right side in FIG. 2 and can be used to produce a high whey protein, sport or nutritional beverage 10″.

Starting with the left hand stream, a sweetener 20 and a flavoring 22 are added to the permeate 32. Optionally, as explained above with reference to FIG. 1, a food grade acidulant 14, a pH neutralizer 16 and/or an enzyme 18 could also be added at this time. The enzyme 18 could be lactase. Lactase is an enzyme occurring in certain yeasts and in the intestinal juices of mammals. Lactase is capable of splitting lactose into glucose and galactose, Less than about 0.2% of an enzyme is added to the permeate 32.

All the optional ingredients should be added to the permeate 32 before the mixture or combination is heated in order to pasteurize it. This mixture is then pasteurized 24 by heating it to a temperature of at least about 161° F. Desirably, the mixture is heated to a temperature of about 172° F. or higher. The mixture can be retained at the elevated temperature for a short time period, of from between about 15 seconds to about 30 seconds to assure that proper pasteurization 24 has occurred. After pasteurization 24, the mixture is cooled to a temperature of about 50° F. or less. Desirably, the mixture is cooled to a temperature of from between about 40° F. to about 45° F. The cooled mixture is a sport beverage 10′ which is high in calcium.

The sport beverage 10′ can then be packaged into containers 28. The containers 28 can vary in size, shape, construction, material, etc. The containers 28 can be rigid containers, such as plastic or glass bottles, or flexible containers, such as plastic pouches. Other kinds and types of containers 28 can also be used as are known to those skilled in the art. The filled containers 28 can be marketed as a sports beverage 10′ which is high in calcium. Fluid acid whey 12 is naturally high in calcium at about 103 milligrams (mg) per 100 grams of fluid acid whey. Fluid acid whey permeate 32 from the ultra filtration 30 will have approximately the same calcium concentration as the starting fluid acid whey 12. The sports beverage 10′ will have about 103 mg of calcium per 100 grams. The filled container 28 can then be stored, shipped and sold to the general public. The filled containers 28 should be refrigerated or kept at a temperature of about 50° F. or less until the sport beverage 10′ is consumed.

The right hand stream in FIG. 2 is a protein rich material which can be used to produce a high protein, nutritional beverage 10″. The material that does not pass through the membrane of the ultra filtration 30 is called retentate 34. A sweetener 20 and a flavoring 22 are added to the retentate 34. Optionally, as explained above with reference to the left hand stream, a food grade acidulant 14, a pH neutralizer 16 and/or an enzyme 18 could also be added at this time. The enzyme 18 could be lactase. Lactase is an enzyme occurring in certain yeasts and in the intestinal juices of mammals. Lactase is capable of splitting lactose into glucose and galactose. Less than about 0.2% of an enzyme is added to the retentate 34.

All the optional ingredients should be added to the retentate 34 before the mixture or combination is heated in order to pasteurize it. This mixture is then pasteurized 24 by heating it to a temperature of at least about 161° F. Desirably, the mixture is heated to a temperature of about 172° F. or higher. The mixture can be retained at the elevated temperature for a short time period, of from between about 15 seconds to about 30 seconds to assure that proper pasteurization 24 has occurred, After pasteurization 24, the mixture is cooled to a temperature of about 50° F. or less. Desirably, the mixture is cooled to a temperature of from between about 40° F. to about 45° F. The cooled mixture is a high protein, nutritional beverage 10″. The nutritional beverage 10″ is then packaged into containers 28. The containers 28 can vary in size, shape, construction, material, etc. The containers 28 can be rigid containers, such as plastic or glass bottles, or flexible containers, such as plastic pouches. Other kinds and types of containers 28 can also be used as are known to those skilled in the art. The filled containers 28 can be marketed as a high protein, nutritional beverage 10″. The filled container 28 can then be stored, shipped and sold to the general public. The filled containers 28 should be refrigerated or kept at a temperature of about 50° F. or less until the nutritional beverage 10″ is consumed.

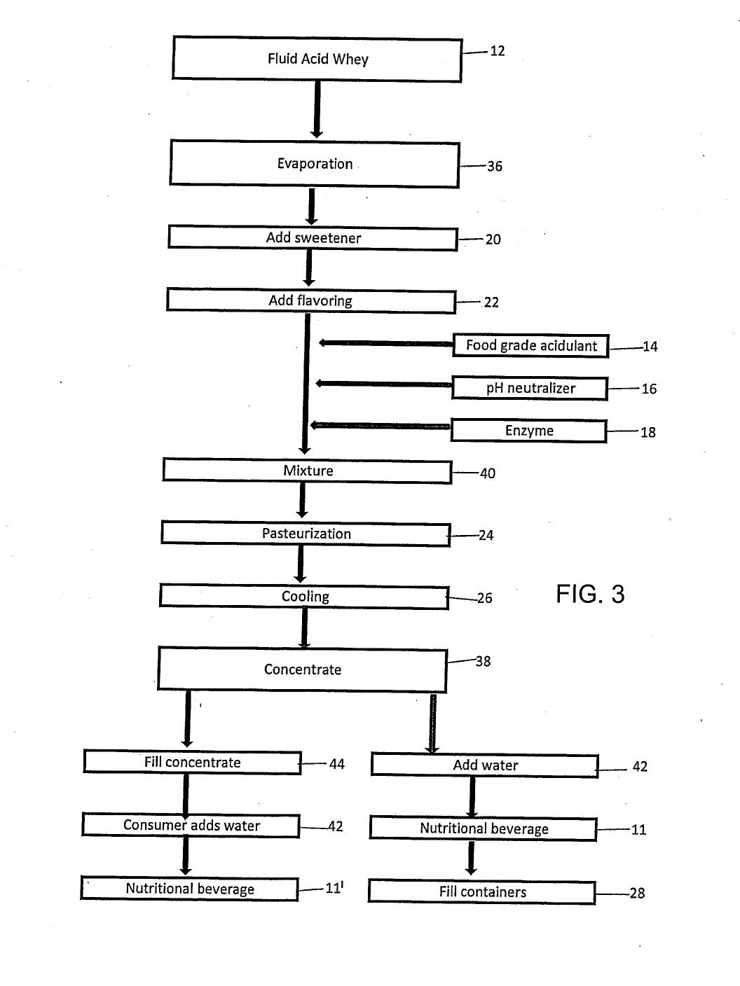

Referring now to FIG. 3, a flow diagram is shown which represents a nutritional beverage 11 which can be made from fluid acid whey 12. The fluid acid whey 12 undergoes evaporation 36 to remove water and to concentrate solids. Evaporation 36 forms a concentrate 38. During evaporation 36, the solids in the fluid acid whey 12 are increased from about 6% to as high as about 30%. Solids refer to the protein, lactose, and minerals in the fluid acid whey 12. The composition of fluid acid whey 12 can vary. For making the nutritional beverage 11, the starting fluid acid whey 12 will have a composition of about 93.6% water, about 6.4% solids, about 0.5% protein, about 4.4% lactose, and about 0.6% minerals. After evaporation 36, the percent solids in the concentrate 38 will be higher. A sweetener 20 and a flavoring 22 are added to the concentrate 38. Optionally, as explained above with reference to FIG. 2, a food grade acidulant 14, a pH neutralizer 16 and/or an enzyme 18 could also be added at this time. The enzyme 18 could be lactase. Lactase is an enzyme occurring in certain yeasts and in the intestinal juices of mammals. Lactase is capable of splitting lactose into glucose and galactose. Less than about 0.2% of an enzyme is added to the concentrate 38.

The sweetener 20, the flavoring 22 and all of the optional ingredients should be added to the concentrate 38 to create a mixture 40, The mixture 40 is heated in order to pasteurize it. This mixture 40 is then pasteurized 24 by heating it to a temperature of at least about 161° F. Desirably, the mixture 40 is heated to a temperature of about 172° F. or higher. The mixture 40 can be retained at the elevated temperature for a short time period, of from between about 15 seconds to about 30 seconds to assure that proper pasteurization 24 has occurred. After pasteurization 24, the mixture 40 is cooled to a temperature of about 50° F. or less. Desirably, the mixture 40 is cooled to a temperature of from between about 40° F. to about 45° F. The mixture 40 can then be split into two separate streams. In the right hand stream, water 42 is added to the cooled mixture 40 to produce the nutritional beverage 11. The water 42 can be added by the beverage manufacturer at the location where the mixture 40 was produced or at a separate facility.

It should be understood that the beverage manufacturer can buy the cooled mixture 40 from a business that produces and evaporates the fluid acid whey 12. Alternatively, the nutritional beverage 11 manufacturer can perform the entire process starting with the fluid acid whey 12, evaporate it and then produce the cooled mixture 40.

In the left hand stream in FIG. 3, the cooled mixture 40 is a concentrate 44. The concentrate 44 is inserted or packaged into containers 28. The containers 28 can vary in size, shape, construction, material, etc. The containers 28 can be rigid containers, such as plastic or glass bottles, or flexible containers, such as plastic pouches. Other kinds and types of containers 28 can also be used as are known to those skilled in the art. The containers 28 filled with the concentrate 44 can be marketed to form a nutritional beverage 11′ once water 42 is added to it. The filled containers 28 can then be stored, shipped and sold to the general public. The filled containers 28 should be refrigerated or be kept at a temperature of about 50° F. or less until the nutritional beverage 11 is mixed with water 42 by the ultimate consumer and consumed.

The shelf life of the nutritional concentrate 44 can be about 60 days or longer, when refrigerated. For consumption by the ultimate consumer, the consumer adds water 42 to the nutritional concentrate 11′ to form the nutritional beverage 11′. Fluid acid whey that is concentrated from about 6.4% solids to about 19.2% solids forms a 3X concentration. The nutritional beverage 11′ which is produced can be equal to what is discussed in FIG. 1 by making a mixture of about 33.3% acid whey concentrate 44 and 66.7% water 42. In other words, one (1) part of the concentrate 44 to two (2) parts water 42.

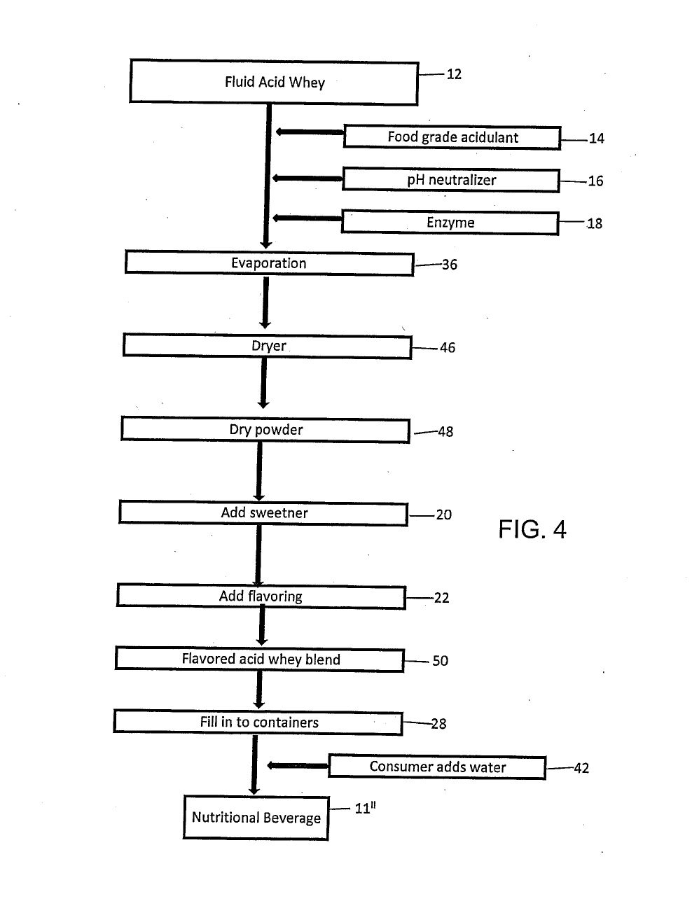

Referring now to FIG. 4, a flow diagram represents a nutritional beverage 11″ made from fluid acid whey 12 using evaporation 36 and a dryer 46, such as a spray dryer, to remove about 95% of the moisture from the fluid acid whey 12 and create a free flowing, acid whey dry powder 48. Optionally, a food grade acidulant 14, a pH neutralizer 16 and/or an enzyme 18 could be added to the fluid acid whey 12 before evaporation 36. The enzyme 18 could be lactase. Lactase is an enzyme occurring in certain yeasts and in the intestinal juices of mammals. Lactase is capable of splitting lactose into glucose and galactose. Less than about 0.2% of an enzyme is added to the fluid acid whey 12.

The evaporation 36 and drying 46 removes moisture from the fluid acid whey 12 and forms a dry powder 48. A sweetener 20 and a flavoring 22 are then added to the dry powder 48 to form a flavored acid whey blend 50. The flavored acid whey blend 50 is at room temperature. The flavored acid whey blend 50 can be packaged into containers 28. The containers 28 can vary in size, shape, construction, material, etc. The containers 28 can be rigid containers, such as plastic or glass bottles, or flexible containers, such as plastic pouches. Other kinds and types of containers 28 can also be used as are known to those skilled in the art. The filled containers 28 can be sold to the ultimate consumer. Once purchased, the consumer will add water 42 and mix to create the nutritional beverage 11″. The filled containers 28 can then be stored, shipped and sold to the general public. The filled containers 28 do not need to be refrigerated. The flavored acid whey blend 50 can be mixed with water 42 to form the nutritional beverage 11″. The water 42 can vary in temperature. The water 42 can be tap water, cold water or ice water. Once the nutritional beverage 11″ is produced by mixing the flavored acid whey blend 50 with water 42, it can be immediately consumed.

In FIG. 4, two experiments were conducted starting with acid whey dry powder 48 from Saputo Diary Foods USA. Saputo Diary Foods USA has an office in Tulare, Calif. Seven (7) parts of acid whey dry powder 48 were mixed with three (3) parts of natural pomegranate flavoring from Carmi Flavor & Fragrances Co., Inc. to make a powdered blend 50. Carmi Flavor & Fragrances Co., Inc has an office at 6030 Scott Way, Commerce, Calif. 90040. Fifty (50) grams of the powdered blend 50 was dissolved in 450 grams of water to form 500 grams of the nutritional beverage 11″.

In a second experiment, 34 grams of acid whey dry powder 48, from Saputo Diary Foods USA, was mixed with 2.32 grams of Crystal Light Peach Mango Green Tea drink mix. This combination was mixed to from a nutritional blend 50. “Crystal Light” is a product of Kraft Foods Group Brands LLC having an office at Three Lakes Drive, Northfield, Ill. 60093. 36.32 grams of the nutritional blend 50 was dissolved in 457 grams of water to form 493.32 grams of the nutritional beverage 11″.

### Method of Forming a Gelatin Dessert

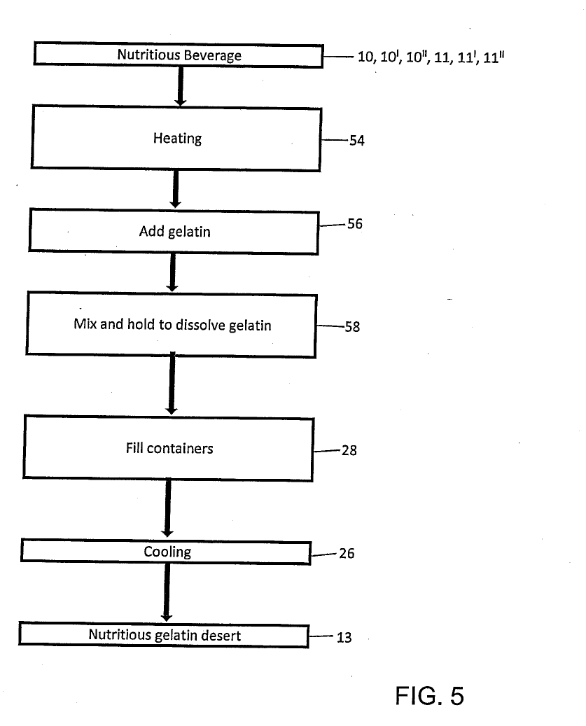

Referring now to FIG. 5, a method of forming a gelatin dessert 13 will be described in connection with the flow diagram. The gelatin dessert 13 is formed by starting with a nutritional beverage 10, 10′, 10″, 11, 11′ or 11″. If the nutritional beverage 10, 10′, 10″, 11, 11′ or 11″ is not in a liquid state, then water can be added to the dry powder to form a liquid composition. This liquid composition is heated 54 to a temperature of about 200° F. or higher. A gelatin 56 is added to this heated nutritional beverage 10, 10′, 10″, 11′ 11′ or 11″. The gelatin 56 can be a solid in dry powder form. The gelatin 56 can be at room temperature. The gelatin 56 is mixed with the heated nutritional beverage 10, 10′, 10″, 11′ 11′ or 11″ to form a mixture 58. The mixing causes the gelatin 56 to become suspended in the heated nutritional beverage 10, 10′, 10″, 11′ 11′ or 11″. By holding the gelatin 56 in the heated nutritional beverage 10, 10′, 10″, 11′ 11′ or 11″ for a short period of time, approximately 2 minutes, one can be assured that the gelatin 56 will be pasteurized and become completely dissolved in the heated nutritional beverage 10, 10′, 10″, 11′ 11′ or 11″.

During the mixing and holding process, the temperature of the mixture 58 will decrease slightly, somewhere in the range of from between about 100° F. to about 175° F. This mixture 58 is then packaged into containers 28 while being at above room temperature. The containers 28 can vary in size, shape, construction, material, etc. The containers 28 can be rigid containers, such as plastic or glass bottles, or flexible containers, such as plastic pouches. Other kinds and types of containers 28 can also be used as are known to those skilled in the art.

The filled containers are then cooled 26, such as by refrigeration, to a temperature of about 50° F. or less. Desirably, the mixture 58 is cooled to a temperature of from between about 40° F. to about 45° F. The cooled mixture forms the nutritional gelatin dessert 13.

The gelatin dessert 13 can include from between about 95% to about 99% by weight of fluid acid whey 12 and from between about 1% to about 5% by weight of the gelatin 56. Desirably, the gelatin dessert 13 includes from between about 96% to about 99% by weight of fluid acid whey 12 and from between about 1% to about 4% by weight of the gelatin 56. More desirably, the gelatin dessert 13 includes from between about 97% to about 99% by weight of fluid acid whey 12 and from between about 3% to about 1% by weight of the gelatin 56. Most desirably, the gelatin dessert 13 includes from between about 98% to about 99% by weight of fluid acid whey 12 and from between about 1% to about 2% by weight of the gelatin 56.

The gelatin dessert 13 can also include other ingredients, such as a food grade acidulant 14, a pH neutralizer 16 and/or an enzyme 18. In addition, a salt, a colorant, or some other ingredient can be added, if desired. Examples of other ingredients include, but are not limited to: magnesium and Vitamin A, B, C or D.

Such ingredients can add additional benefits for bone health. While the invention has been described in conjunction with several specific embodiments, it is to be understood that many alternatives, modifications and variations will be apparent to those skilled in the art in light of the foregoing description. Accordingly, this invention is intended to embrace all such alternatives, modifications and variations which fall within the spirit and scope of the appended claims.

I claim:

1. A nutritional beverage comprising from between about 80% to about 99% by weight of fluid acid whey, from between about 0.001% to about 10% by weight of a sweetener, and from between about 0.25% to about 10% by weight of a flavoring.

2. The nutritional beverage of claim 1 further comprising a food grade acidulant.

3. The nutritional beverage of claim 1 further comprising a pH neutralizer.

4. The nutritional beverage of claim 3 wherein said pH neutralizer is sodium bicarbonate, sodium phosphate or sodium hydroxide.

5. The nutritional beverage of claim 1 further comprising an enzyme.

6. The nutritional beverage of claim 5 wherein said enzyme is a lactase enzyme.

7. The nutritional beverage of claim 1 wherein said fluid acid whey can be a concentrate, a permeate or be treated to be a dry powder.

8. The nutritional beverage of claim 7 wherein said permeate is obtained by ultra filtration of said fluid acid whey.

9. The nutritional beverage of claim 1 wherein a gelatin is added to said nutritional beverage to produce a nutritious gelatin dessert.

10. A nutritional beverage comprising from between about 50% to about 90% by weight fluid acid whey and from between about 10% to about 50% by weight of juice.

11. The nutritional beverage of claim 10 further comprising from between about 50% to about 75% by weight fluid acid whey and from between about 25% to about 50% by weight of juice.

12. The nutritional beverage of claim 10 wherein said juice is apple juice.

13. The nutritional beverage of claim 10 further comprising charging said nutritional beverage 10 with carbon dioxide gas.

14. The nutritional beverage of claim 10 wherein said fluid acid whey is a permeate.

15. The nutritional beverage of claim 14 wherein said permeate is obtained by subjecting said fluid acid whey to ultra filtration.

16. A method of forming a nutritional beverage comprising the steps of:
a) heating fluid acid whey to a temperature of about 161° F. for a predetermined period of time to pasteurize it;
b) adding from between about 50% to about 90% by weight of said pasteurized fluid acid whey with from between about 10% to about 50% by weight of a juice to form a mixture; and
c) cooling said mixture to a temperature of less than about 55° F. to form said nutritional beverage.

17. The method of claim 16 further comprising transferring said nutritional beverage to individual containers, sealing said containers, and refrigerating said containers.

18. The method of claim 17 further comprising refrigerating said containers to a temperature of about 40° F.

19. The method of claim 16 further comprising adding magnesium and vitamin D to said fluid acid whey before said heating.

20. The method of claim 16 wherein said fluid acid whey is heated to a temperature of about 172° F.
